(19) United States
(12) Patent Application Publication
(10) Pub. No.: US 2014/0134869 A1
(43) Pub. Date: May 15, 2014

(54) JOINT CONNECTOR

(71) Applicant: YAZAKI CORPORATION, Tokyo (JP)

(72) Inventors: Tsuyoshi HAMAI, Makinohara-shi (JP); Takumi NAKAGISHI, Makinohara-shi (JP); Tomihiko NAGAYOSHI, Makinohara-shi (JP)

(73) Assignee: YAZAKI CORPORATION, Tokyo (JP)

(21) Appl. No.: 14/157,575

(22) Filed: Jan. 17, 2014

Related U.S. Application Data
(63) Continuation of application No. PCT/JP2012/068218, filed on Jul. 18, 2012.

(30) Foreign Application Priority Data
Jul. 19, 2011 (JP) 2011-157793

(51) Int. Cl. H01R 13/62

(52) U.S. Cl. CPC H01R 13/62
USPC 439/345

(57) ABSTRACT

A lever connector includes a connector housing that has a terminal reception chamber, a joint terminal that is fixed to the connector housing and arranged in the terminal reception chamber, a connection terminal that is to be received in the terminal reception chamber by insertion thereof so as to contact with the joint terminal by elastic deformation of elastic contact pieces, and a locking means that locks the connection terminal received in the terminal reception chamber with the joint terminal to fix the connection terminal. The locking means has locking grooves provided on the joint terminal and locking tabs provided on wall parts that support the elastic contact pieces of the connection terminal.

### CROSS REFERENCE TO RELATED APPLICATION

This is a continuation application based on PCT application No. PCT/JP2012/068218 filed on Jul. 18, 2012, which claims the benefit of priority from Japanese Patent Application No. 2011-157793 filed on Jul. 19, 2011, the entire contents of which are incorporated by reference herein.

### BACKGROUND OF THE INVENTION

1. Field of the Invention

The present invention relates to a joint connector to electrically connect a plurality of connection terminals which are, for example, connected to electric wires, respectively.

2. Description of the Related Art

As this kind of conventional joint connector, one disclosed in Patent Literature 1 (Japanese Patent Application Laid-Open Publication No. H11-329569) has been proposed. As shown in FIGS. 1 and 2, a joint connector 50 includes a connector housing 51 which has two terminal reception chambers 52, two joint terminals 61 which are fixed to the connector housing 51 and disposed in the terminal reception chambers 52, respectively, and two connection terminals 70 which are to be received in the terminal reception chambers 52, respectively, by insertion thereof so as to contact with the joint terminals 61, respectively, by elastic deformation of elastic contact pieces 71.

The joint terminals 61 are electrically connected through a connection portion 62 which is formed in one body with the joint terminals 61. Each of the joint terminals 61 is formed with a locking hole 61a. Each of the connection terminals 70 includes the elastic contact piece 71. Each of the connection terminals 70 is made to contact with the joint terminal 61 by elastic deformation of the elastic contact piece 71. The elastic contact piece 71 is provided with a locking tab 71a which is cut and raised therefrom. That is, the locking hole 61a of the joint terminal 61 and the locking tab 71a of the connection terminal 70 configure a locking means 53.

In the above-described configuration, when the connection terminal 70 is inserted into the terminal reception chamber 52, the elastic contact piece 71 contacts with the joint terminal 61. When the connection terminal 70 is inserted from this state to an insertion completed position, a position of the locking tab 71a of the elastic contact piece 71 matches with a position of the locking hole 61a of the joint terminal 61. Thereby, the locking tab 71a is locked with the locking hole 61a by a movement of the elastic contact piece 71 in an elastic restoration direction. Thus, the fitting of the connection terminal 70 is completed. If both of the connection terminals 70 are fitted in the terminal reception chambers 52, respectively, in this way, the connection terminals 70 are made to be in an electrically connected state.

Since the connection terminal 70 is locked with the joint terminal 61 by the locking means 53, even if the pull force or the like acts on the connection terminal 70, the connection terminal 70 is not moved in a pull direction of the terminal reception chamber 52, thereby not causing a poor contact or the like.

However, in the above-described conventional joint connector 50, if the pull force acts on the connection terminal 70, it acts on the locking tab 71a of the elastic contact piece 71 and the inside of the locking hole 61a of the joint terminal 61. There is a risk that the elastic contact piece 71 is deformed by the pull force. Particularly, the elastic contact piece 71 is a part which is easily elastically deformed, and thus the elastic contact piece 71 is easily deformed by the above-described pull force. If the elastic contact piece 71 is deformed, it lowers reliability of the contact.

### SUMMARY OF THE INVENTION

In view of the above, the present invention has an object to provide a joint connector capable of improving the contact reliability in locking a connection terminal with a joint terminal.

According to an aspect of the present invention, there is provided a joint connector including: a connector housing that has a terminal reception chamber; a joint terminal that is fixed to the connector housing and arranged in the terminal reception chamber; a connection terminal that has an elastic contact piece and is to be received in the terminal reception chamber by insertion thereof so as to contact with the joint terminal by elastic deformation of the elastic contact piece; and a locking unit that locks the connection terminal received in the terminal reception chamber with the joint terminal to fix the connection terminal, wherein the locking unit has a locking groove provided on the joint terminal, and a locking tab provided on a wall part of the connection terminal, the wall part supporting the elastic contact piece of the connection terminal.

According to an aspect of the present invention, the locking unit has a pair of locking grooves and a pair of locking tabs, the pair of locking grooves is provided on both edge parts of the joint terminal such that positions of the locking grooves are shifted with respect to an insertion direction of the connection terminal, and the pair of locking tabs is provided on a pair of wall parts such that positions of the locking tabs are shifted with respect to the insertion direction of the connection terminal.

According to the aspect of the present invention, since the pull force on the connection terminal acts on the locking tab of the wall part which supports the elastic contact piece and on the inside of the locking groove of the joint terminal, it does not directly act on the elastic contact piece and thus the elastic contact piece is not easily deformed. It is therefore possible to improve the contact reliability in locking the connection terminal with the joint terminal.

### BRIEF DESCRIPTION OF THE DRAWINGS

FIG. 1 is a perspective view of a conventional joint connector.

FIG. 2 is a longitudinal sectional view of the conventional joint connector when a connection terminal is fitted therein.

FIG. 3 is a perspective view of a joint connector according to an exemplary embodiment of the present invention.

FIG. 4 is a perspective view of the joint connector according to the exemplary embodiment of the present invention when viewed from a side opposite to FIG. 3.

FIG. 5A is a longitudinal sectional view of the joint connector according to the exemplary embodiment of the present invention when connection terminals are fitted therein.

FIG. 5B is a cross sectional view of the joint connector according to the exemplary embodiment of the present invention when connection terminals are fitted therein.

FIG. 6 is an enlarged view of A in FIG. 5B.

FIG. 7A is a perspective view of a joint busbar according to the exemplary embodiment of the present invention.

FIG. 7B is a plan view of the principal part of a joint terminal according to the exemplary embodiment of the present invention.

FIG. 7C is a plan view of the principal part of a joint terminal when right and left locking grooves are arranged at the same position.

FIG. 8 is a perspective view of a connection terminal according to the exemplary embodiment of the present invention.

FIG. 9A is a longitudinal sectional view of the joint connector according to the exemplary embodiment of the present invention when the connection terminals are in the middle of fitting.

FIG. 9B is a cross-sectional view of the joint connector according to the exemplary embodiment of the present invention when the connection terminals are in the middle of fitting.

FIG. 10 is a perspective view of a connection terminal according to a modification of the exemplary embodiment of the present invention.

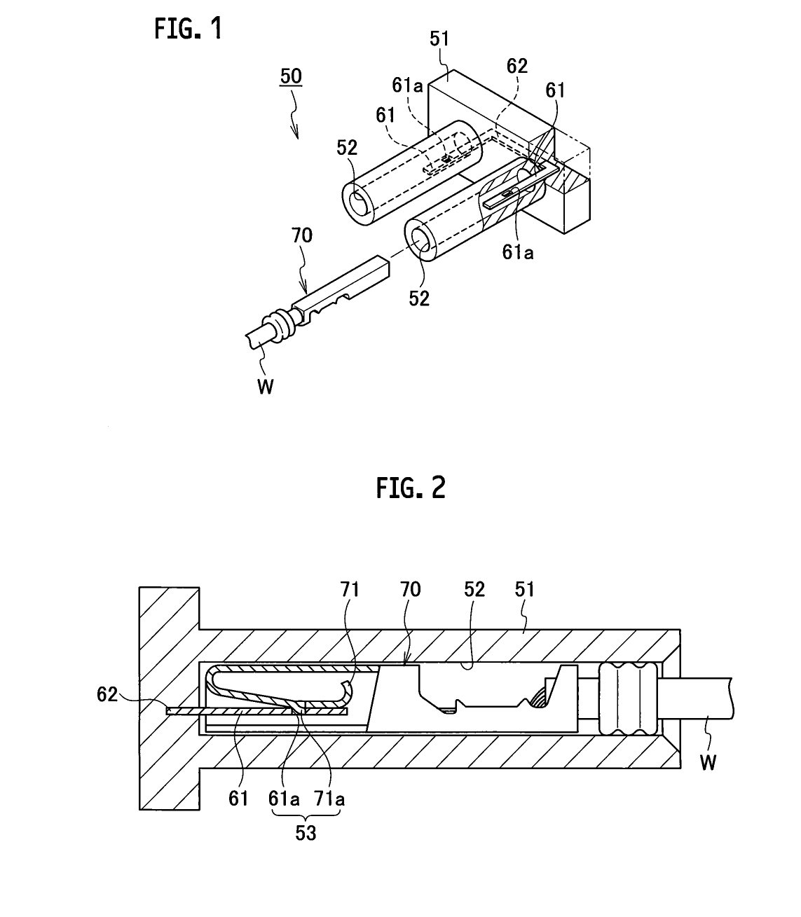

### DESCRIPTION OF THE EMBODIMENTS

An exemplary embodiment of the present invention will be described with reference to the drawings.

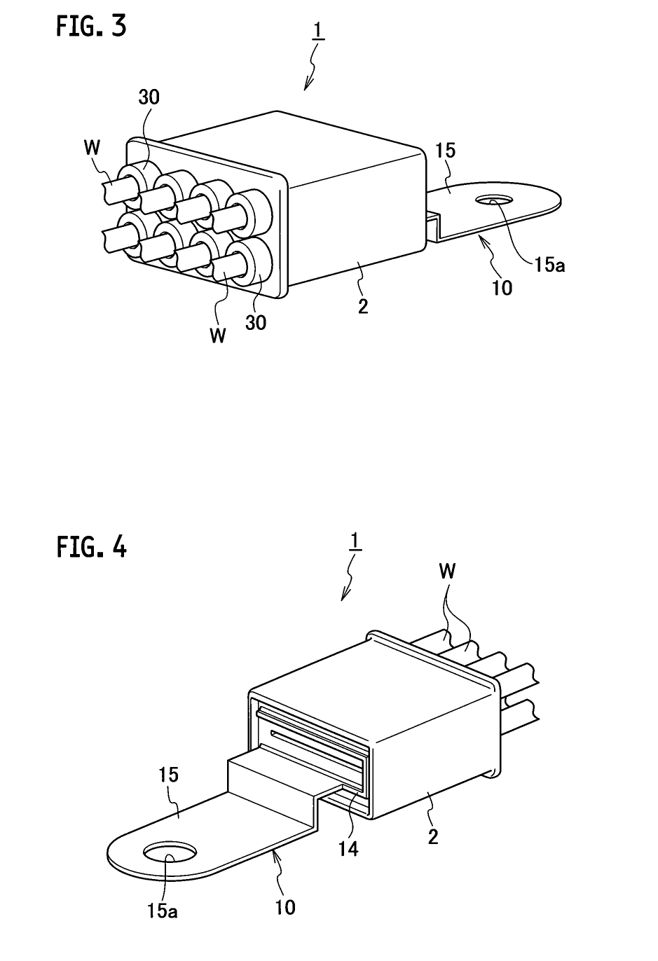

FIGS. 3 to 9B show an exemplary embodiment of the present invention. As shown in FIGS. 3 to 5B, a joint connector 1 includes a connector housing 2 which has a plurality of terminal reception chambers 3, a joint busbar 10 which is fixed to the connector housing 2 by press-fitting or the like, and a plurality of connection terminals 20 which is received in the plurality of terminal reception chambers 3 by insertion thereof.

The terminal reception chambers 3 are arranged horizontally in an array of four chambers and vertically in two stages.

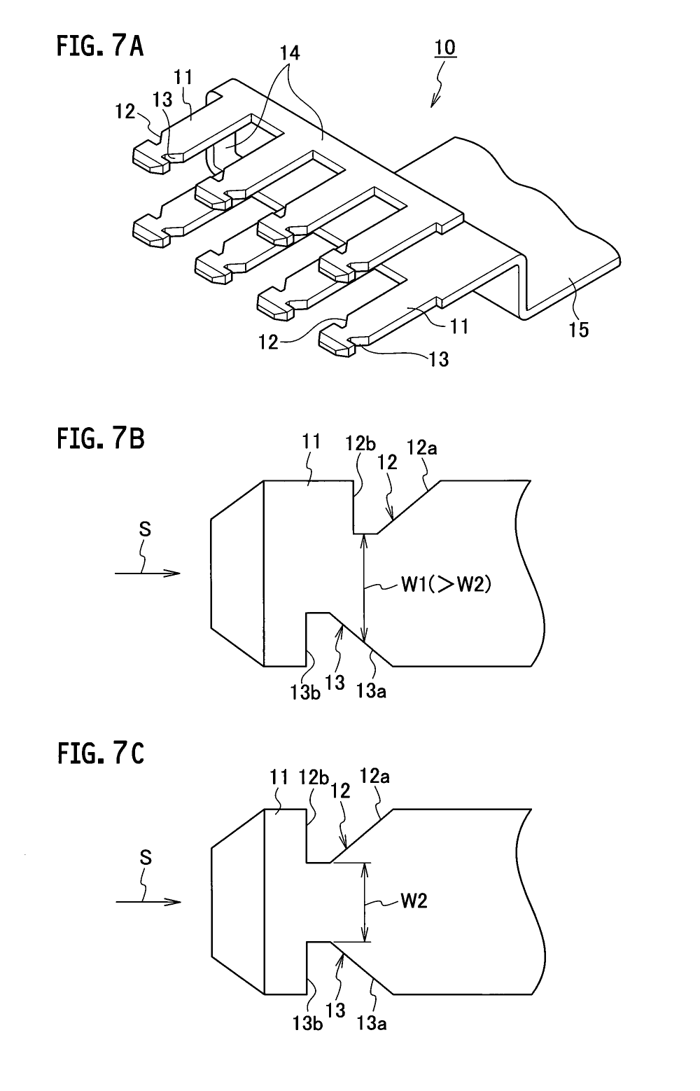

As show in FIG. 7A, the joint busbar 10 is formed of conductive metal material as one body. The joint busbar 10 includes eight joint terminals 11, a joint plate portion 14 which joints the joint terminals 11 together, and a mounting plate portion 15 which is provided to extend from the joint plate portion 14. Each of the joint terminals 11 is disposed in each of the terminal reception chambers 3 in a protruding state. Each of the joint terminals 11 has a tab terminal shape. As shown in FIG. 7B in detail, each of the joint terminals 11 has a pair of locking grooves 12 and 13 at the tip thereof. The pair of locking grooves 12 and 13 is formed by cutting both end surfaces of the joint terminal 11 such that their positions are shifted with respect to an insertion direction S of the connection terminal 20. That is, as shown in FIG. 7C, if the pair of locking grooves 12 and 13 is formed by cutting the both end surfaces at the same position, the narrowest width (shearing area) W2 of the joint terminal 11 is reduced. On the other hand, in the present invention, as shown in FIG. 7B, the narrowest width (shearing area) W1 of the joint terminal 11 is enlarged by cutting the both end surfaces such that their positions are shifted.

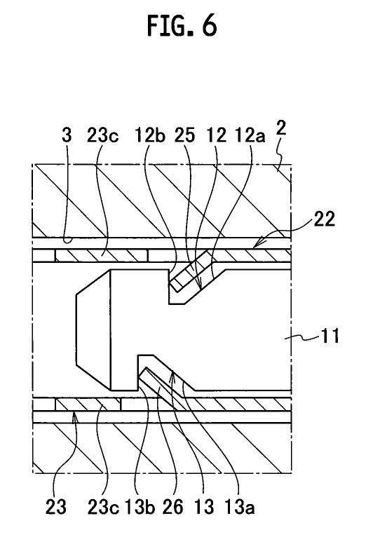

The locking grooves 12 and 13 include inclined inside surfaces 12a and 13a and vertical inside surfaces 12b and 13b, respectively. As shown in FIG. 6 in detail, the inclined inside surfaces 12a and 13a enable locking tabs 25 and 26, which will be described later, to be locked, and the vertical inside surfaces 12b and 13b prevent unlocking of the locking tabs 25 and 26 by pull force.

The mounting plate portion 15 protrudes from the rear side of the connector housing 2. The mounting plate portion 15 is provided in the same height with the bottom of the connector housing 2. The mounting plate portion 15 is provided with a bolt penetration hole 15a. For example, when electric wires W connected to the connection terminals 20 are set to a ground potential, the mounting plate portion 15 is fixed to a portion which makes a ground route.

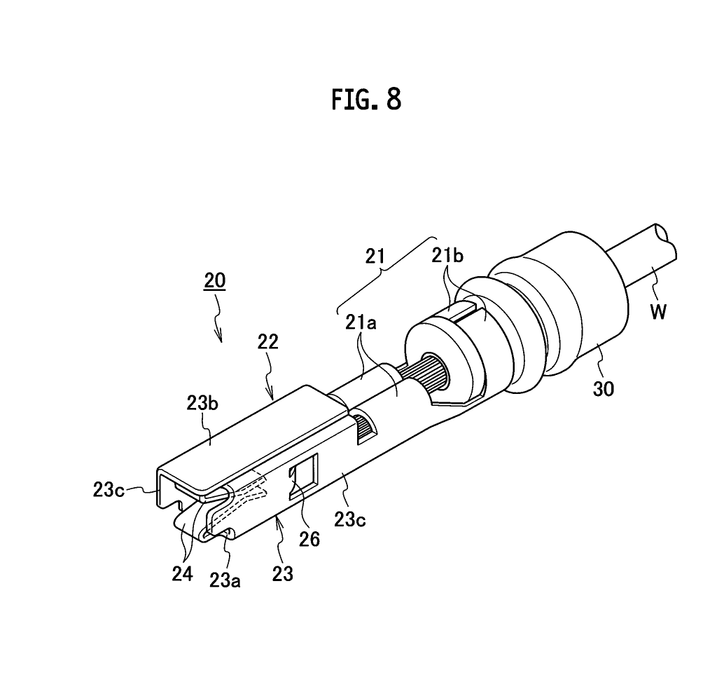

As shown in FIG. 8, etc., each of the connection terminals 20 is fixed to the end part of each electric wire W. Each of the connection terminals 20 is formed by bend-processing a plate of conductive metal material having a predetermined shape. Each of the connection terminals 20 includes an electric wire connection portion 21 and a corresponding terminal contact portion 22.

The electric wire connection portion 21 includes crimping parts 21a and 21b at two places. The crimping part 21b at one of the two places has a rubber stopper 30 attached thereto. The electric wire W is inserted into the rubber stopper 30 and fixed by crimping the crimping parts 21a and 21b of the electric wire connection portion 21. The fixation of the electric wire W by crimping also fixes the rubber stopper 30 by crimping.

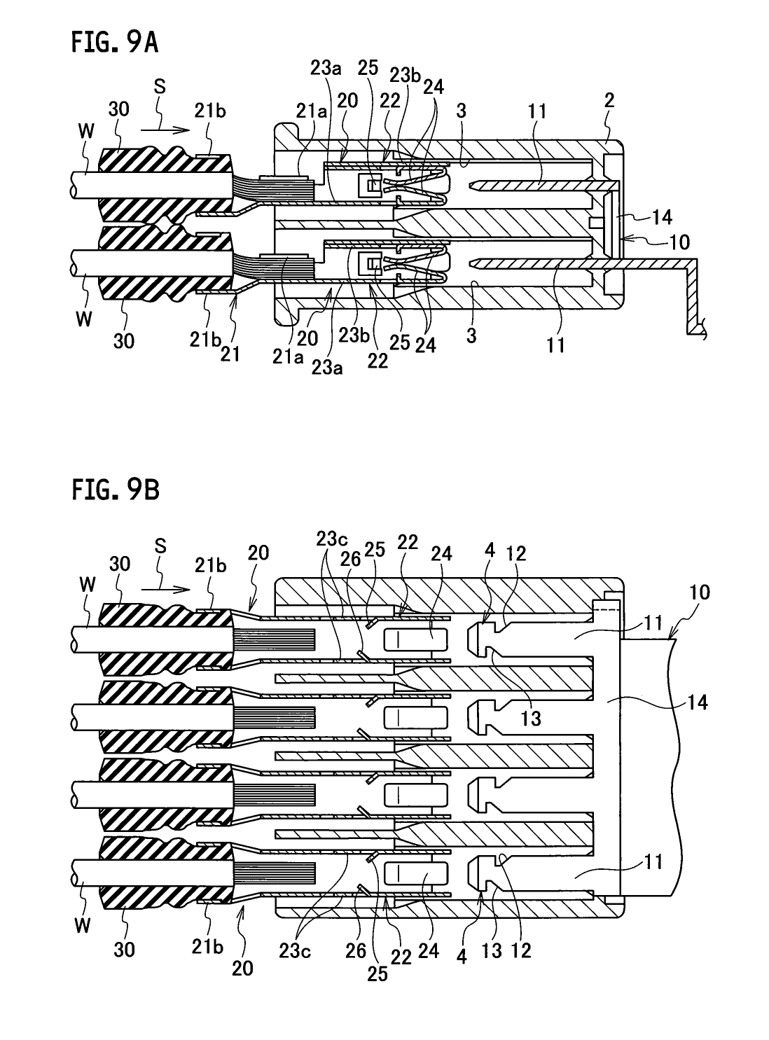

The corresponding terminal contact portion 22 has a square box part 23 which is formed of a bottom wall part 23a, a top wall part 23b, and a pair of side wall parts 23c on the right and left, and a pair of elastic contact pieces 24 which extends respectively from the bottom wall part 23a and the top wall part 23b toward the inside of the square box part 23. The pair of elastic contact pieces 24 has its gap gradually narrowed from the front of the square box part 23 toward the rear so as to almost contact each other at the back (refer to FIGS. 9A and 9B).

In a state where the connection terminal 20 is fitted in the terminal reception chamber 3, the pair of elastic contact pieces 24 of the connection terminal 20 secures the joint terminal 11 from both sides by elastic restoration force. Thereby, it stabilizes the contact of the connection terminal 20 with the joint terminal 11.

The pair of side wall parts 23c on the right and left is provided with a pair of locking tabs 25 and 26 by cutting and raising toward inside of the square box part 23. The pair of locking tabs 25 and 26 is arranged such that their positions are shifted with respect to the insertion direction S of the connection terminal 20, as well as the pair of locking grooves 12 and 13. In the state where the connection terminal 20 is fitted in the terminal reception chamber 3, the pair of locking tabs 25 and 26 of the connection terminal 20 is locked with the pair of locking grooves 12 and 13 of the joint terminal 11. That is, the pair of locking tabs 25 and 26 of the connection terminal 20 and the pair of locking grooves 12 and 13 of the joint terminal 11 configure a locking means 4.

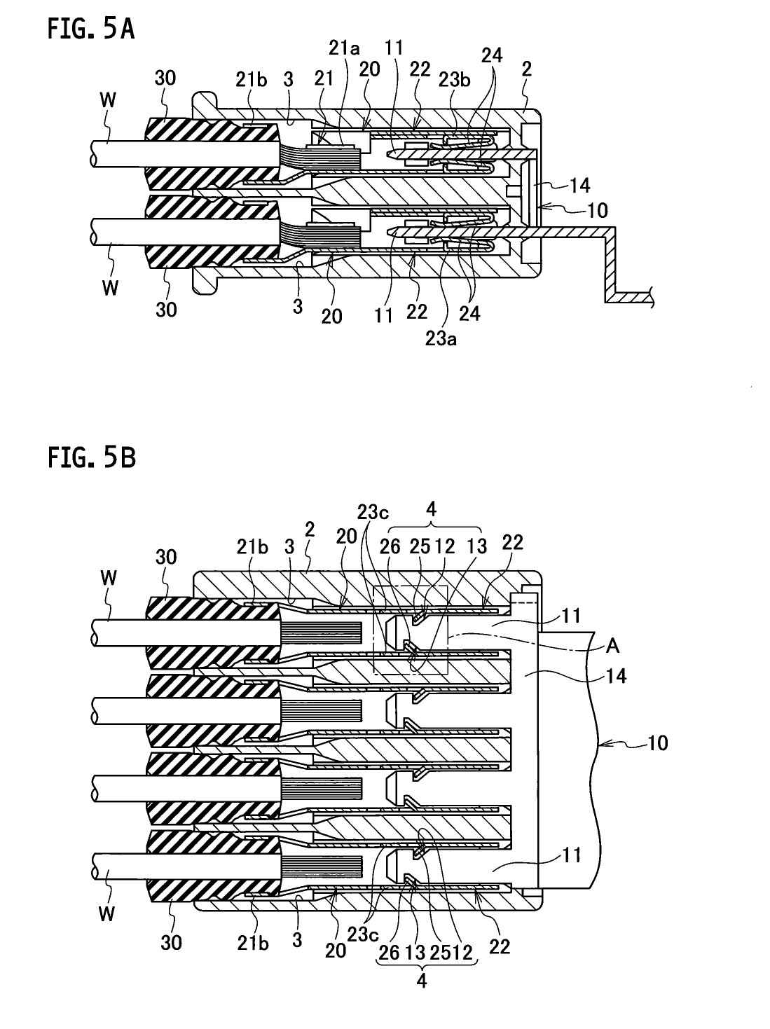

In the above-described configuration, as shown in FIGS. 9A and 9B, the connection terminal 20 is inserted into the terminal reception chamber 3. Then, the joint terminal 11 enters the gap between the pair of elastic contact pieces 24 of the connection terminal 20 such that the pair of elastic contact pieces 24 contacts with the joint terminal 11. If the connection terminal 20 is further inserted into the interior from this state, the pair of elastic contact pieces 24 is elastically deformed in a direction for widening the gap, thereby allowing the insertion of the joint terminal 11. If the insertion of the connection terminal 20 is advanced, the pair of locking tabs 25 and 26 of the connection terminal 20 then contacts with the joint terminal 11. If the connection terminal 20 is further inserted into the interior from this state, the pair of locking tabs 25 and 26 is elastically deformed, thereby allowing the insertion of the connection terminal 20. If the connection terminal 20 is then inserted to an insertion completed position, as shown in FIGS. 5A and 5B, the positions of the pair of locking tabs 25 and 26 match with the positions of the locking grooves 12 and 13 of the joint terminal 11. Thereby, the pair of locking tabs 25 and 26 is locked with the pair of locking grooves 12 and 13 by the elastic restoration deformation thereof. At the insertion completed position, the joint terminal 11 is sandwiched between the pair of elastic contact pieces 24 of the connection terminal 20 so as to be in a normal contact state. At the insertion completed position, the rubber stopper 30 has a state where its front insertion part is press-fitted into the terminal reception chamber 3. Thus, the fitting of the connection terminal 20 is completed.

If a predetermined number of connection terminals 20 are fitted in the terminal reception chambers 3, respectively, by the above-described insertion operations, all fitted connection terminals 20 are made to be electrically connected together through the joint busbar 10. For example, when the joint busbar 10 is connected to a ground route, each of the electric wires W of all the connection terminals 20 is made to be grounded. Since each of the connection terminals 20 is locked with the joint terminal 11 by the locking means 4, this prevents the connection terminal 20 from moving in a pulling out direction of the terminal reception chamber 3 to cause a bad contact and the like, even though the pull force or the like acts on the connection terminal 20.

Besides, the locking means 4 includes the locking grooves 12 and 13 provided on the joint terminal 11, and the locking tabs 25 and 26 provided on the side wall parts 23c which support the elastic contact pieces 24 of the connection terminal 20. Thus, the pull force on the connection terminal 20 acts on the locking tabs 25 and 26 on the side wall parts 23c which support the elastic contact pieces 24, and on the inside of the locking grooves 12 and 13 of the joint terminal 11, and does not directly act on the elastic contact pieces 24. Thereby, the elastic contact pieces 24 are not easily deformed. From the above, it is possible to improve the contact reliability in the locking of the connection terminal 20 with the joint terminal 11.

The locking grooves 12 and 13 are provided on the both edge parts of the joint terminal 11 as a pair such that their positions are shifted with respect to the insertion direction S. The locking tabs 25 and 26 are provided on the pair of side wall parts 23c of the connection terminal 20 such that their positions are shifted with respect to the insertion direction S. That is, the pull force on the connection terminal 20 is distributed to act on the locking tabs 25 and 26 on the right and left. Thereby, it is possible to prevent the incline of the connection terminal 20 by the pull force to the utmost. The joint terminal 11 has the pair of locking grooves 12 and 13 provided such that their positions are shifted on the right and left thereof. Compared with the case where the pair of locking grooves 12 and 13 is provided at the same position on the right and left, the joint terminal 11 has the narrowest width (shearing area) wider, thereby restraining the max shearing stress by the pull force to a low level so as to improve the terminal holding force.

Since the rubber stopper 30 fitted around the electric wire W is press-fitted into the terminal reception chamber 3, it is possible to surely prevent the infiltration of water and the like into the terminal reception chamber 3.

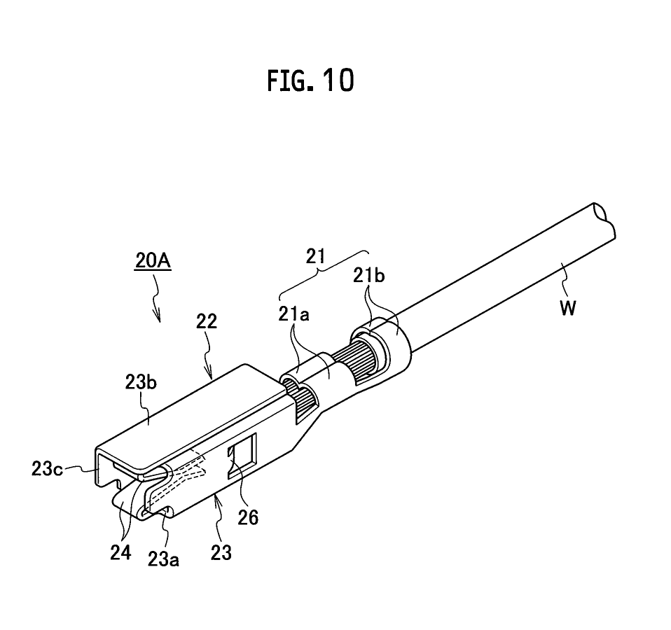

FIG. 10 is a perspective view of a connection terminal 20A according to a modification of the present exemplary embodiment. As shown in FIG. 10, the connection terminal 20A is one without the rubber stopper. Since other parts of the configuration are same as those in the above-described exemplary embodiment, same reference numbers are given to the same configuration parts and explanations are omitted.

With the connection terminal 20A of the modification, the same action and effect as the above-described exemplary embodiment is obtained except for the waterproof efficiency.

What is claimed is:

1. A joint connector comprising:
a connector housing that has a terminal reception chamber;
a joint terminal that is fixed to the connector housing and arranged in the terminal reception chamber;
a connection terminal that has an elastic contact piece and is to be received in the terminal reception chamber by insertion thereof so as to contact with the joint terminal by elastic deformation of the elastic contact piece; and
a locking unit that locks the connection terminal received in the terminal reception chamber with the joint terminal to fix the connection terminal,
wherein the locking unit has a locking groove provided on the joint terminal, and a locking tab provided on a wall part of the connection terminal, the wall part supporting the elastic contact piece of the connection terminal.

2. The joint connector according to claim 1,
wherein the locking unit has a pair of locking grooves and a pair of locking tabs,
the pair of locking grooves is provided on both edge parts of the joint terminal such that positions of the locking grooves are shifted with respect to an insertion direction of the connection terminal, and
the pair of locking tabs is provided on a pair of wall parts such that positions of the locking tabs are shifted with respect to the insertion direction of the connection terminal.
